(19) United States
(12) Patent Application Publication
(10) Pub. No.: US 2006/0082306 A1
(43) Pub. Date: Apr. 20, 2006

(54) Plasma display panel (PDP) and its method of manufacture

(76) Inventor: Jung-Suk Song, Suwon-si (KR)

Correspondence Address: Robert E. Bushnell, Suite 300, 1522 K Street, N.W., Washington, DC, 20005-1202, US

(21) Appl. No.: 11/232,014

(22) Filed: Sep. 22, 2005

(30) Foreign Application Priority Data
Oct. 19, 2004 (KR) 10-2004-0083499

(51) Int. Cl. H01J 17/49

(52) U.S. Cl. 313/583; 313/582; 313/586

(57) ABSTRACT

A Plasma Display Panel (PDP) and its method of manufacture includes: a first substrate; a plurality of first discharge electrodes arranged on the first substrate; a second substrate arranged opposite to the first substrate and in parallel therewith; a plurality of second discharge electrodes arranged on the second substrate to cross the first discharge electrodes, the second discharge electrodes being adapted to be addressed with the first discharge electrodes and located on different levels; barrier ribs disposed between the first and second substrates to define discharge cells; and Red (R), Green (G), and Blue (B) phosphor layers coated on lateral sides of the barrier ribs. Address electrodes for discharge cells coated with R, G, and B phosphor layers are positioned on different levels, so that address voltages become more uniform regardless of the color of a phosphor layer.

### CLAIM OF PRIORITY

This application makes reference to, incorporates the same herein, and claims all benefits accruing under 35 U.S.C.§119 from an application for PLASMA DISPLAY PANEL AND METHOD OF MANUFACTURING THE SAME earlier filed in the Korean Intellectual Property Office on 19 Oct. 2004 and there duly assigned Serial No. 10-2004-0083499.

### BACKGROUND OF THE INVENTION

1. Field of the Invention

The present invention relates to a Plasma Display Panel (PDP), and more particularly, to a PDP that can be driven with a low voltage by differentiating thicknesses of dielectric layers that bury discharge electrodes, and its method of manufacture.

2. Description of the Related Art

Typically, Plasma Display Panels (PDPs) are flat display panels that display desired numbers, characters, or graphics by discharging a gas injected between two substrates each having discharge electrodes and exciting a phosphor layer using ultraviolet rays generated from the discharged gas.

Such PDPs can be classified into Direct Current (DC) PDPs and Alternating Current (AC) PDPs according to patterns of waveforms of driving voltages supplied to discharge cells, for example, according to the form of discharge. Such PDPs can also be classified into opposed discharge PDPs and surface discharge PDPs according to the arrangement of electrodes.

A three-electrode surface discharge PDP includes a front substrate and a rear substrate, which are arranged to face each other.

X and Y electrodes are arranged on an inner surface of the front substrate in such a way that an X electrode and a Y electrode are both located within each discharge cell. The X electrode includes a first electrode line, which is transparent, and a first bus electrode, which is overlapped by the first electrode line. The Y electrode includes a second electrode line, which is transparent, and a second bus electrode, which is overlapped by the second electrode line. The X and Y electrodes are buried in a front dielectric layer. The front dielectric layer is coated with a protective layer.

Address electrodes are arranged on an inner surface of the rear substrate to cross the X and Y electrodes. The address electrodes are buried in a rear dielectric layer.

Barrier ribs are formed within a space between the front and rear substrates to define discharge cells. The discharge cells defined by the barrier ribs are coated with a Red phosphor layer R, a Green phosphor layer G, and a Blue phosphor layer B.

Briefly looking at a process of manufacturing the PDP having the above-described structure, the X and Y electrodes are first arranged in parallel on the inner surface of the front substrate. Then, a raw material for the front dielectric layer is printed on the entire inner surface of the resultant front substrate so that the X and Y electrodes can be buried in the material. Thereafter, the front dielectric layer is formed through drying and other predetermined processes, and the protective layer is deposited on the front dielectric layer.

After the address electrodes are arranged in parallel on the inner surface of the rear substrate, a raw material for the rear dielectric layer is printed on the entire inner surface of the resultant rear substrate so that the Y electrodes can be buried in the material. Thereafter, the rear dielectric layer is formed through drying and other predetermined processes.

Thereafter, the barrier ribs are formed on the rear substrate, and a Red phosphor layer R, a Green phosphor layer G, and a Blue phosphor layer B are repeatedly formed on the discharge cells defined by adjacent barrier ribs.

Through this process, the front and rear substrates are completed.

As to the discharge characteristics of the PDP described above, because the red, green, and blue phosphor layers R, G, and B have different discharge characteristics, voltage margins Va, which are minimal address voltages required upon addressing, are different for the R. G, and B phosphor layers.

For example, when the voltage Vₛₑₜ is 170V, an address voltage Vₐ of a discharge cell coated with the blue phosphor layer B is about 55V, while an address voltage Vₐ of a discharge cell coated with the red phosphor layer R is about 63V.

In practice, at least an address voltage Vₐ for a discharge cell coated with a Red phosphor layer, which has the smallest voltage margin Vₐ, must be used to drive the PDP. Thus, a driving circuit for the PDP is overloaded.

### SUMMARY OF THE INVENTION

The present invention provides a PDP which reduces a variation among voltage margins of Red, Green, and Blue phosphor layers by differentiating thicknesses of dielectric layers that bury discharge electrodes corresponding to discharge cells coated with the R, G, and B phosphor layers, thereby increasing the overall voltage margin, and a method of manufacturing the PDP.

According to one aspect of the present invention, a Plasma Display Panel (PDP) is provided comprising: a first substrate; a plurality of first discharge electrodes arranged on the first substrate; a second substrate arranged opposite to the first substrate and in parallel therewith; a plurality of second discharge electrodes arranged on the second substrate to cross the first discharge electrodes, the second discharge electrodes being adapted to be addressed with the first discharge electrodes and located on different levels; barrier ribs disposed between the first and second substrates to define discharge cells; and Red (R), Green (G), and Blue (B) phosphor layers coated on lateral sides of the barrier ribs.

Second discharge electrodes corresponding to discharge cells coated with R, G, and B phosphor layers are preferably different distances away from the first discharge electrodes.

Second discharge electrodes corresponding to discharge cells having higher voltage margins are preferably farther from the first discharge electrodes than second discharge electrodes corresponding to discharge cells having lower voltage margins.

Second discharge electrodes corresponding to discharge cells coated with R, G, and B phosphor layers are preferably buried in parts of a dielectric layer of different thicknesses.

Parts of the dielectric layer that bury the second discharge electrodes corresponding to discharge cells coated with R, G, and B phosphor layers preferably have different thicknesses to differentiate intervals from the second discharge electrodes to each of the first discharge electrodes.

Parts of the dielectric layer that bury the second discharge electrodes corresponding to the discharge cells having higher voltage margins are preferably thicker than parts of the dielectric layer that bury the second discharge electrodes corresponding to the discharge cells having lower voltage margins.

The dielectric layer preferably becomes thinner in a direction from a part that buries the second discharge electrode corresponding to the discharge cell having the greatest voltage margin to a part that buries the second discharge electrode corresponding to the discharge cell having the lowest voltage margin.

The first discharge electrodes preferably include X and Y electrodes that are alternately arranged so that a pair of X and Y electrodes are arranged within each discharge cell, and the second discharge electrodes are address electrodes preferably arranged to cross the X and Y electrodes.

The address electrodes preferably include first address electrodes arranged under the discharge cells coated with a first one of the R, G, and B phosphor layers, second address electrodes arranged under the discharge cells coated with a second one of the R, G, and B phosphor layers, and third address electrodes arranged under the discharge cells coated with a third one of the R, G, and B phosphor layers; and the first, second, and third address electrodes are preferably arranged to be different distances away from the X and Y electrodes.

The first address electrodes, which are arranged under the discharge cells having higher voltage margins, are preferably farther from the X and Y electrodes than the third address electrodes, which are arranged under the discharge cells having lower voltage margins.

Parts of the dielectric layer that bury the first, second, and third discharge electrodes preferably have different thicknesses to differentiate intervals from the first, second, and third discharge electrodes to each of the X and Y electrodes.

According to another aspect of the present invention, a method of manufacturing a Plasma Display Panel (PDP) is provided, the method comprising: arranging first discharge electrodes on a first substrate: arranging a second substrate to be opposite to the first substrate; and arranging a plurality of second discharge electrodes on the second substrate at different levels, the plurality of second discharge electrodes being adapted to be addressed by the first discharge electrodes; and forming a dielectric layer to bury the second discharge electrodes.

The second discharge electrodes are preferably arranged under discharge cells coated with Red (R), Green (G), and Blue (B) phosphor layers to be different distances away from the first discharge electrodes.

Second discharge electrodes corresponding to discharge cells having higher voltage margins are preferably arranged farther from the first discharge electrodes than second discharge electrodes corresponding to discharge cells having lower voltage margins.

Parts of the dielectric layer that bury the second discharge electrodes arranged under the discharge cells coated with R, G, and B phosphor layers are preferably formed to have different thicknesses.

Forming the second discharge electrodes and the dielectric layer preferably comprises: forming first electrodes for use as the second discharge electrodes on parts of the second substrate that are under discharge cells coated with a first one of Red (R), Green (G), and Blue (B) phosphor layers; forming a first dielectric layer to bury the first electrodes; forming second electrodes for use as the second discharge electrodes on parts of the first dielectric layer that are under the discharge cells coated with a second one of the R, G, and B phosphor layers; forming a second dielectric layer to bury the second electrodes; forming third electrodes for use as the second discharge electrodes on parts of the second dielectric layer that are under the discharge cells coated with the phosphor layers of a third one of the R, G, and B phosphor layers; and forming a third dielectric layer to bury the third electrodes.

According to still another aspect of the present invention, a Plasma Display Panel (PDP) manufactured by a method is provided, the method comprising: arranging first discharge electrodes on a first substrate: arranging a second substrate to be opposite to the first substrate; and arranging a plurality of second discharge electrodes on the second substrate at different levels, the plurality of second discharge electrodes being adapted to be addressed by the first discharge electrodes; and forming a dielectric layer to bury the second discharge electrodes.

The second discharge electrodes are preferably arranged under discharge cells coated with Red (R), Green (G), and Blue (B) phosphor layers to be different distances away from the first discharge electrodes.

Second discharge electrodes corresponding to discharge cells having higher voltage margins are preferably arranged farther from the first discharge electrodes than second discharge electrodes corresponding to discharge cells having lower voltage margins.

Parts of the dielectric layer that bury the second discharge electrodes arranged under the discharge cells coated with R, G, and B phosphor layers are preferably formed to have different thicknesses.

Forming the second discharge electrodes and the dielectric layer preferably comprises: forming first electrodes for use as the second discharge electrodes on parts of the second substrate that are under discharge cells coated with a first one of Red (R), Green (G), and Blue (B) phosphor layers; forming a first dielectric layer to bury the first electrodes; forming second electrodes for use as the second discharge electrodes on parts of the first dielectric layer that are under the discharge cells coated with a second one of the R, G, and B phosphor layers; forming a second dielectric layer to bury the second electrodes; forming third electrodes for use as the second discharge electrodes on parts of the second dielectric layer that are under the discharge cells coated with the phosphor layers of a third one of the R, G, and B phosphor layers; and forming a third dielectric layer to bury the third electrodes.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a PDP;

FIG. 2 is a graph of differences among voltage margins for red, green, and blue phosphors versus Vₛₑₜ for the PDP of FIG. 1;

FIG. 3 is an exploded perspective view of a PDP according to an embodiment of the present invention;

FIG. 4 is a cross-section taken along line I-I of FIG. 3;

FIG. 5 is a flowchart of a method of manufacturing the PDP of FIG. 3;

FIG. 6 is a graph of the tendencies of voltage margins in a PDP; and

FIG. 7 is a graph of the tendencies of voltage margins in a PDP according to the embodiment of FIG. 3, as compared to that of the PDP of FIG. 6.

### DETAILED DESCRIPTION OF THE INVENTION

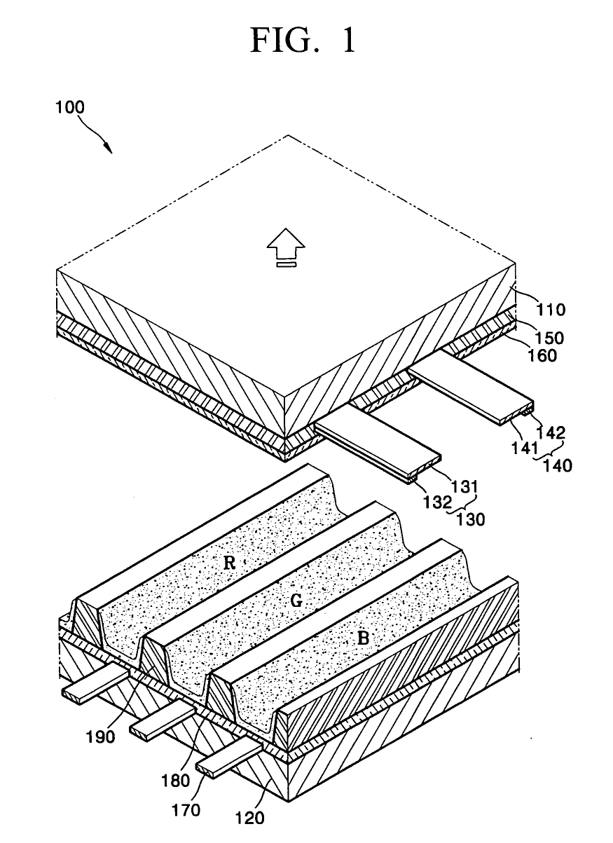

FIG. 1 is an exploded perspective view of a three-electrode surface discharge PDP 100. Referring to FIG. 1, the PDP 100 includes a front substrate 110 and a rear substrate 120, which are arranged to face each other.

X and Y electrodes 130 and 140 are arranged on an inner surface of the front substrate 110 in such a way that an X electrode 130 and a Y electrode 140 are both located within each discharge cell. The X electrode 130 includes a first electrode line 131, which is transparent, and a first bus electrode 132, which is overlapped by the first electrode line 131. The Y electrode 140 includes a second electrode line 141, which is transparent, and a second bus electrode 142, which is overlapped by the second electrode line 141. The X and Y electrodes 130 and 140 are buried in a front dielectric layer 150. The front dielectric layer 150 is coated with a protective layer 160.

Address electrodes 170 are arranged on an inner surface of the rear substrate 120 to cross the X and Y electrodes 130 and 140. The address electrodes 170 are buried in a rear dielectric layer 180.

Barrier ribs 190 are formed within a space between the front and rear substrates 110 and 120 to define discharge cells. The discharge cells defined by the barrier ribs 190 are coated with a red phosphor layer R, a green phosphor layer G, and a blue phosphor layer B.

Briefly looking at a process of manufacturing the PDP 100 having the above-described structure, the X and Y electrodes 130 and 140 are first arranged in parallel on the inner surface of the front substrate 110. Then, a raw material for the front dielectric layer 150 is printed on the entire inner surface of the resultant front substrate 110 so that the X and Y electrodes 130 and 140 can be buried in the material. Thereafter, the front dielectric layer 150 is formed through drying and other predetermined processes, and the protective layer 160 is deposited on the front dielectric layer 150.

After the address electrodes 170 are arranged in parallel on the inner surface of the rear substrate 110, a raw material for the rear dielectric layer 180 is printed on the entire inner surface of the resultant rear substrate 120 so that the Y electrodes 170 can be buried in the material. Thereafter, the rear dielectric layer 180 is formed through drying and other predetermined processes.

Thereafter, the barrier ribs 190 are formed on the rear substrate 10, and a Red phosphor layer R, a Green phosphor layer G, and a Blue phosphor layer B are repeatedly formed on the discharge cells defined by adjacent barrier ribs 190.

Through this process, the front and rear substrates 110 and 120 are completed.

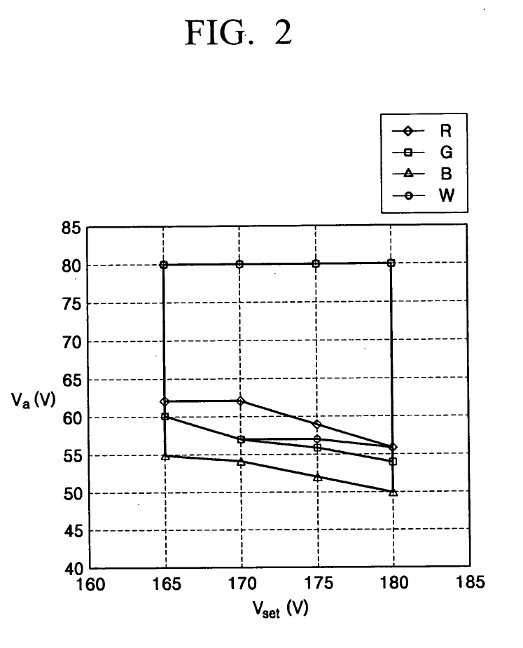

Discharge characteristics of the PDP 100 are shown in FIG. 2. In FIG. 2, the X axis indicates a voltage Vₛₑₜ used to accumulate wall charges in a reset stage, and the Y axis indicates an address voltage Vₐ.

As shown in FIG. 2, because the red, green, and blue phosphor layers R, G, and B have different discharge characteristics, voltage margins Va, which are minimal address voltages required upon addressing, are different for the red, green, and blue phosphor layers R, G, and B.

For example, when the voltage Vₛₑₜ is 170V, an address voltage Vₐ of a discharge cell coated with the blue phosphor layer B is about 55V as shown in curved line B, while an address voltage Vₐ of a discharge cell coated with the red phosphor layer R is about 63V as shown in curved line R.

In practice, at least an address voltage Vₐ for a discharge cell coated with a red phosphor layer, which has the smallest voltage margin Vₐ, must be used to drive the PDP 100. Thus, a driving circuit for the PDP 100 is overloaded.

A PDP according to an embodiment of the present invention is described below with reference to the accompanying drawings.

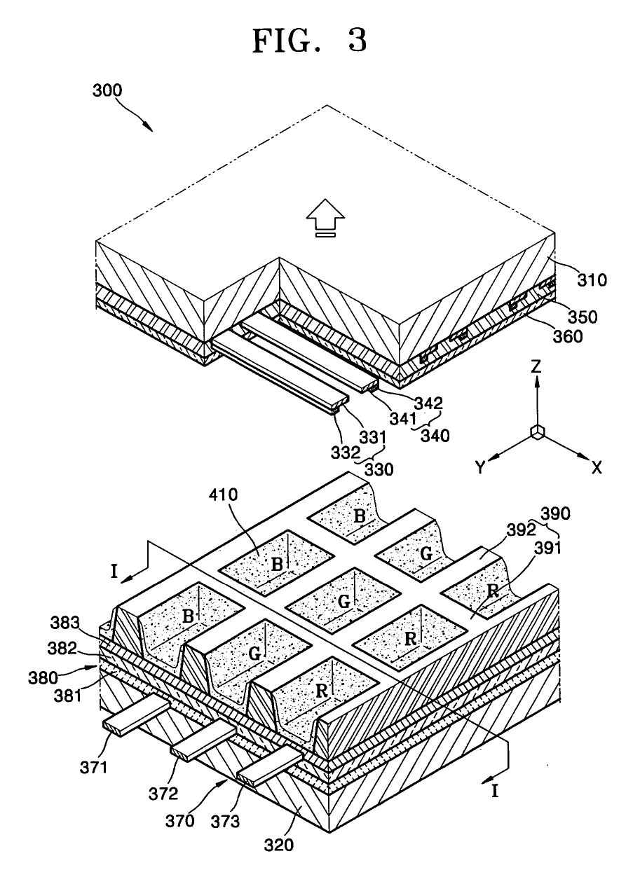

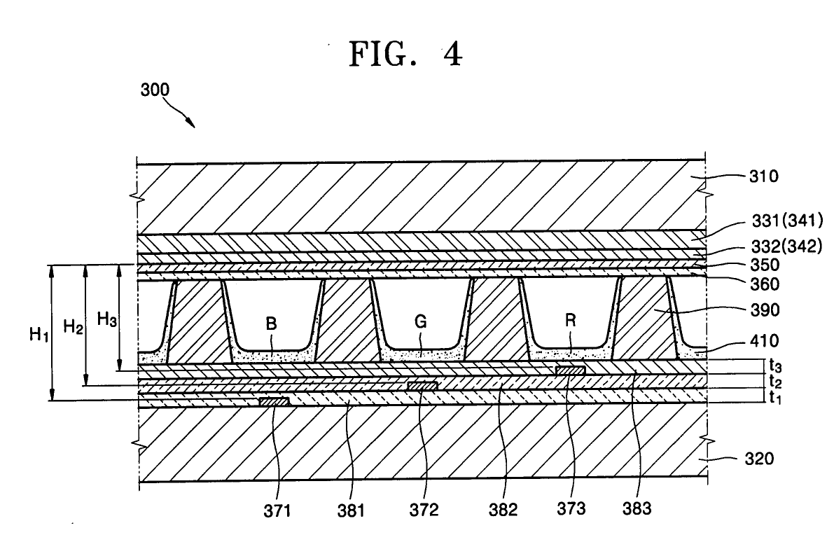

FIG. 3 is an exploded perspective view of a PDP 300 according to an embodiment of the present invention. FIG. 4 is a cross-section of the PDP 300 taken along line I-I of FIG. 3.

Referring to FIGS. 3 and 4, the PDP 300 includes a front substrate 310 and a rear substrate 320 which are arranged to face each other in parallel. The front and rear substrates 310 and 320 are attached together by frit glass coated on the edges of the facing inner surfaces thereof and then sealed.

The front substrate 310 is formed of a transparent material, for example, soda lime glass. X and Y electrodes 330 and 340, which are discharge sustain electrodes, are arranged at regular intervals in direction Y on the inner surface (i.e., the bottom surface) of the front substrate 310. The X and Y electrodes 330 and 340 alternate.

An X electrode 330 includes a first electrode line 331, which is transparent and formed on the inner surface of the front substrate 310, and a first bus electrode 332, which is formed on some area of the first electrode line 331. The Y electrode 340 includes a second electrode line 341, which is transparent and formed on the inner surface of the front substrate 310, and a second bus electrode 342, which is formed on some area of the second electrode line 341.

The first and second electrode lines 331 and 341 are disposed in pairs within each discharge cell and are formed of a transparent material, for example, Indium Tin Oxide (ITO), to improve the aperture ratio of the front substrate 310. The first and second bus lines 332 and 342 are formed of highly conductive metal, for example, silver (Ag) paste or a chrome-copper-chrome alloy, to reduce resistances of the first and second electrode lines 331 and 341 and to improve electrical conductivity.

A space between a pair of X and Y electrodes 330 and 340 and an adjacent pair of X and Y electrodes 330 and 340 is a non-discharge area. The non-discharge area can include a black stripe layer to improve the contrast of the PDP 300.

The X and Y electrodes 330 and 340 are buried in the front dielectric layer 350. The front dielectric layer 350 is formed by adding a variety of fillers to a glass paste. The front dielectric layer 350 can be printed on only parts of the bottom surface of the front substrate 310 on which the X and Y electrodes 330 and 340 are formed. Alternatively, the front dielectric layer 350 can be printed on the entire bottom surface of the front substrate 310. A protective layer 360, which is formed of Magnesium Oxide (MO), for example, is deposited on the front dielectric layer 350 to protect the front dielectric layer 350 and increase the amount of secondary electrons emitted.

Address electrodes 370 are arranged on the inner surface of the rear substrate 320 to cross the X and Y electrodes 330 and 340. The address electrodes 370 are buried in a rear dielectric layer 380.

Barrier ribs 390 are formed within a space between the front and rear substrates 310 and 320 to define discharge cells. The barrier ribs 390 include first barrier ribs 391, which are disposed in an X direction of the panel 300, and second barrier ribs 392, which are disposed in a Y direction of the panel 300. The first barrier rib 391 extends from sidewalls of a pair of adjacent second barrier ribs 392 in a direction where the sidewalls face each other. The first and second barrier ribs 391 and 392 are combined in a matrix shape.

Alternatively, the barrier ribs 390 can be other various shapes, such as, a meander shape, a delta shape, or a honeycomb shape. Accordingly, a defined discharge cell is not limited to a particular shape, such as, a polygon other than a rectangle or a circle.

A discharge gas, such as, neon-xenon or helium-xenon, is injected into the discharge cells defined by the front and rear substrates 310 and 320 and the barrier ribs 390.

The discharge cells are coated with Red (R), Green (G), and Blue (B) phosphor layers 410, which are excited by ultraviolet rays generated by the discharge gas to emit visible light. Although the R, G, and B phosphor layers 410 can be coated on any areas of the discharge cells, they are coated on the inner areas of the barrier ribs 390 in the present embodiment.

A discharge cell is coated with a phosphor layer 410. Preferably, but not necessarily, an R phosphor layer 410 is formed of (Y,Gd)BO₃·Eu⁺³, a G phosphor layer 410 is formed of Zn₂SiO₄:Mn²⁺, and a B phosphor layer 410 is formed of BaMgAl₁₀O₁₇:Eu²⁺.

The rear dielectric layer 380, in which the address electrode 370 is buried, is formed so that parts of the rear electric layer 380 corresponding to discharge cells coated with R, G, and B phosphor layers 410 can have different thicknesses.

More specifically, the address electrodes 370 are arranged on the rear substrate 320 at regular intervals in direction X of the panel 300. The address electrodes 370 in strips are arranged in parallel and extend across centers of the discharge cells in direction Y of the panel 300.

Address electrodes 370 for R, G, and B phosphor layers 410 are not on an identical level. In other words, an interval between the upper surface of the rear dielectric layer 380 and the address electrodes 370 gradually decreases in a direction from a discharge cell coated with the B phosphor layer 410, having the highest voltage margin, to a discharge cell coated with the R phosphor layer 410, having the lowest voltage margin.

To achieve this, a first address electrode 371 is disposed on a part of the upper surface of the rear substrate 320 that is directly under a discharge cell coated with the B phosphor layer 410. The first address electrode 371 extends across the discharge cell coated with the B phosphor layer 410. The first address electrode 371 is buried in the first barrier dielectric layer 381. The first barrier dielectric layer 381 is printed on the entire surface of the rear substrate 320.

A second address electrode 372 is disposed on a part of the upper surface of the rear substrate 320 that is directly under a discharge cell coated with the G phosphor layer 410. The second address electrode 372 extends across the discharge cell coated with the G phosphor layer 410. The second address electrode 372 is buried in a second barrier dielectric layer 382. The second barrier dielectric layer 382 is also printed on the entire surface of the rear substrate 320.

A third address electrode 373 is disposed on a part of the upper surface of the rear substrate 320 that is directly under a discharge cell coated with the R phosphor layer 410. The third address electrode 373 extends across the discharge cell coated with the R phosphor layer 410. The third address electrode 373 is buried in the third barrier dielectric layer 383. The third barrier dielectric layer 383 is printed on the entire surface of the rear substrate 320.

The first, second, and third rear dielectric layers 381, 382, and 383 are formed of substantially the same material and are formed by repeatedly printing the material on the rear substrate 320 in the direction perpendicular to the plane of the rear substrate 320, that is, in the Z direction.

When a distance between the first address electrode 371 directly under the discharge cell coated with the B phosphor layer 410 and the second bus line 342 is H₁, a distance between the second address electrode 372 directly under the discharge cell coated with the G phosphor layer 410 and the second bus line 342 is H₂, and a distance between the third address electrode 373 directly under the discharge cell coated with the R phosphor layer 410 and the second bus line 342 is H₃, the distances decreased in the sequence of H→H2→H3.

When a thickness of the first rear dielectric layer 381, in which the first address electrode 371 corresponding to the discharge cell coated with the B phosphor layer 410, is t₁, a thickness of the second rear dielectric layer 382, in which the second address electrode 372 corresponding to the discharge cell coated with the G phosphor layer 410, is t₂, and a thickness of the third rear dielectric layer 383, in which the third address electrode 373 corresponding to the discharge cell coated with the R phosphor layer 410, is t₃, an interval from a bottom surface of the first rear dielectric layer 381, in which the first address electrode 371 is buried, to the upper surface of the rear dielectric layer 380 is t₁+t₂+t₃. An interval from a bottom surface of the second rear dielectric layer 382, in which the second address electrode 372 is buried, to the upper surface of the rear dielectric layer 380 is t₂+t₃. An interval from a bottom surface of the third rear dielectric layer 383, in which the third address electrode 373 is buried, to the upper surface of the rear dielectric layer 380 is t₃.

Accordingly, a thickness t₁+t₂+t₃ of a part of the rear dielectric layer 380 that buries the first address electrode 371 is the greatest. A thickness t₃ of a part of the rear dielectric layer 380 that buries the third address electrode 373 is the smallest. A thickness t₂+t₃ of a part of the rear dielectric layer 380 that buries the second address electrode 372 is in between the above thicknesses.

Intervals between the first, second, and third address electrodes 371, 372, and 373 and each of the Y electrodes 340 are different. More specifically, the first address electrode 371 corresponding to the discharge cell coated wit the B phosphor layer 410, which has the highest voltage margin, is the farthest from the Y electrodes 340, and the third address electrode 373 corresponding to the discharge cell coated with the R phosphor layer 410, which has the lowest voltage margin, is the closest to the Y electrodes 340. Accordingly, a deviation among voltage margins of discharge cells coated with Red, Green, and Blue phosphor layers can be reduced.

In contrast with this embodiment, depending on the types of Red, Green, and Blue phosphor layers or the structure of barrier ribs, a discharge cell coated with a Red phosphor layer may have the highest voltage margin, or a discharge cell coated with a Green phosphor layer may have the lowest voltage margin.

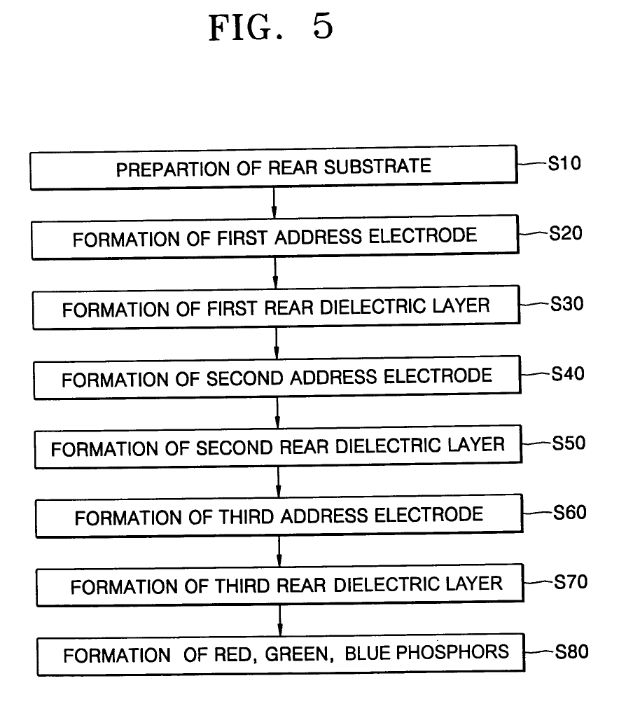

Formations of the address electrodes 370 and the rear dielectric layer 380 during the manufacture of the PDP 300 are described with reference to FIGS. 4 and 5.

First, in step S10, the rear substrate 320 is prepared. Next, in step S20, first address electrodes 371 are arranged in parallel on the surface of the rear substrate 320. The first address electrodes 371 are discharge electrodes extending across discharge cells to be defined later and coated with B phosphor layers 410 having the highest voltage margins.

Then, in step S30, the first rear dielectric layer 381 is printed on the entire surface of the rear substrate 320 to bury the first address electrodes 371.

Thereafter, in step S40, second address electrodes 372 are arranged in parallel on the surface of the first rear dielectric layer 381. The second address electrodes 372 are discharge electrodes extending across discharge cells to be defined later and coated with G phosphor layers 410 having the second highest voltage margins.

Then, in step S50, the second rear dielectric layer 382 is printed on the entire surface of the rear substrate 320 to bury the second address electrodes 372.

Next, in step S60, third address electrodes 373 are arranged in parallel on the surface of the second rear dielectric layer 382. The third address electrodes 373 are discharge electrodes extending across discharge cells that are to be defined later and coated with R phosphor layers 410 having the smallest voltage margins.

Then, in step S70, the third rear dielectric layer 383 is printed on the entire surface of the rear substrate 320 to bury the third address electrodes 373.

By alternating the first, second, and third address electrodes 371, 372, and 373 with the first, second, and third rear dielectric layers 381, 382, and 383 as described above, distances between the first, second, and third address electrodes 371, 372, and 373 for the discharge cells coated with the Red, Green, and Blue phosphor layers, respectively, and the Y electrodes 340 are made different. Consequently, the first, second, and third address electrodes 371, 372, and 373 are covered with different thicknesses of parts of the rear dielectric layer 380.

Then, in step S80, barrier ribs 390 are formed on the rear substrate 320 to define the discharge cells, and the discharge cells are coated with the R, G, and B phosphor layers 410.

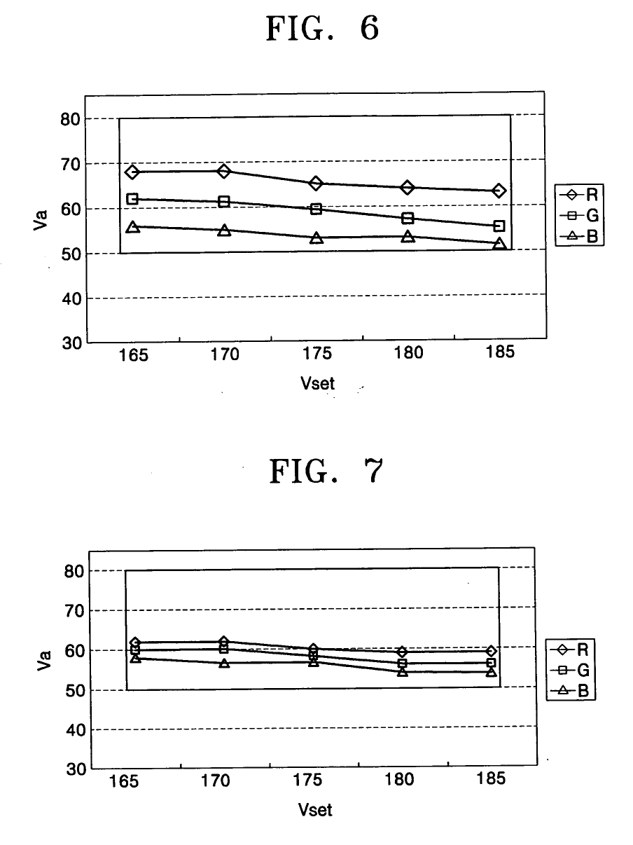

FIG. 6 is a graph of the tendencies of voltage margins in a PDP such as the PDP of FIG. 1. In this PDP, address electrodes for discharge cells coated with Red, Green, and Blue phosphors are located on an identical level.

FIG. 7 is a graph of the tendencies of voltage margins in the PDP according to the embodiment of the present invention of FIG. 3. In this PDP, an address electrode 373, corresponding to a discharge cell coated with the R phosphor layer 410 and having the smallest voltage margin, is disposed to be closest to a Y electrode 340, and an address electrode 371, corresponding to a discharge cell coated with the B phosphor layer 410 and having the highest voltage margin, is disposed to be farthest from the Y electrode 340.

In FIGS. 6 and 7, the X axis indicates a voltage Vₛₑₜ used to accumulate wall charges in a reset stage, and the Y axis indicates an address voltage Vₐ.

Referring to FIG. 6, when the voltage Vₛₑₜ is 170V, an address voltage Vₐ of a discharge cell coated with the R phosphor layer is about 68V, and an address voltage Vₐ of a discharge cell coated with the B phosphor layer is about 55V. Hence, a difference between voltage margins of the discharge cells coated with the R and B phosphor layers is about 13V. An overload of at least 68V is required to drive the panel.

Referring to FIG. 7, when the voltage Vₛₑₜ is 170V, an address voltage Vₐ of a discharge cell coated with the R phosphor layer 410 is about 62V, and an address voltage Vₐ of a discharge cell coated with the B phosphor layer 410 is about 57V. Hence, a difference between the voltage margins of the discharge cells coated with the R and B phosphor layers 410 is about 5V. In other words, a difference between voltage margins in this PDP decreases by about 8V as compared with the PDP in FIG. 6.

Due to this reduction of the difference among the address voltages of the discharge cells coated with the R and B phosphor layers 410, the uniformity of voltages for the PDP improves. In addition, a maximum voltage margin required to drive the panel is 62V, and the voltage margin is improved by about 9% as compared with the PDP in FIG. 6. This reduction of the voltage to drive the panel contributes to stable driving of the panel.

The above-described PDP and the method of manufacturing the same according to the present invention have the following effects. First, address electrodes for discharge cells coated with R, G, and B phosphor layers are positioned on different levels, so that address voltages become more uniform regardless of the color of a phosphor layer.

Second, a thickness of a dielectric layer is optimized according to the discharge characteristics of the discharge cells coated with the R, G, and B phosphor layers, so that a load upon a driving circuit is reduced.

Third, optimization of different discharge voltages depending on the R, G, and B phosphor layers contributes to a reduction in the power consumption and an improvement in the discharge efficiency.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP), comprising:
a first substrate;
a plurality of first discharge electrodes arranged on the first substrate;
a second substrate arranged opposite to the first substrate and in parallel therewith;
a plurality of second discharge electrodes arranged on the second substrate to cross the first discharge electrodes, the second discharge electrodes being adapted to be addressed with the first discharge electrodes and located on different levels;
barrier ribs disposed between the first and second substrates to define discharge cells; and
Red (R), Green (G), and Blue (B) phosphor layers coated on lateral sides of the barrier ribs.

2. The PDP of claim 1, wherein second discharge electrodes corresponding to discharge cells coated with R, G, and B phosphor layers are different distances away from the first discharge electrodes.

3. The PDP of claim 2, wherein second discharge electrodes corresponding to discharge cells having higher voltage margins are farther from the first discharge electrodes than second discharge electrodes corresponding to discharge cells having lower voltage margins.

4. The PDP of claim 1, wherein second discharge electrodes corresponding to discharge cells coated with R, G, and B phosphor layers are buried in parts of a dielectric layer of different thicknesses.

5. The PDP of claim 4, wherein parts of the dielectric layer that bury the second discharge electrodes corresponding to discharge cells coated with R, G, and B phosphor layers have different thicknesses to differentiate intervals from the second discharge electrodes to each of the first discharge electrodes.

6. The PDP of claim 4, wherein parts of the dielectric layer that bury the second discharge electrodes corresponding to the discharge cells having higher voltage margins are thicker than parts of the dielectric layer that bury the second discharge electrodes corresponding to the discharge cells having lower voltage margins.

7. The PDP of claim 4, wherein the dielectric layer becomes thinner in a direction from a part that buries the second discharge electrode corresponding to the discharge cell having the greatest voltage margin to a part that buries the second discharge electrode corresponding to the discharge cell having the lowest voltage margin.

8. The PDP of claim 1, wherein the first discharge electrodes include X and Y electrodes that are alternately arranged so that a pair of X and Y electrodes are arranged within each discharge cell, and wherein the second discharge electrodes are address electrodes arranged to cross the X and Y electrodes.

9. The PDP of claim 8, wherein the address electrodes include first address electrodes arranged under the discharge cells coated with a first one of the R, G, and B phosphor layers, second address electrodes arranged under the discharge cells coated with a second one of the R, G, and B phosphor layers, and third address electrodes arranged under the discharge cells coated with a third one of the R, G, and B phosphor layers; and wherein the first, second, and third address electrodes are arranged to be different distances away from the X and Y electrodes.

10. The PDP of claim 9, wherein the first address electrodes, which are arranged under the discharge cells having higher voltage margins, are farther from the X and Y electrodes than the third address electrodes, which are arranged under the discharge cells having lower voltage margins.

11. The PDP of claim 9, wherein parts of the dielectric layer that bury the first, second, and third discharge electrodes have different thicknesses to differentiate intervals from the first, second, and third discharge electrodes to each of the X and Y electrodes.

12. A method of manufacturing a Plasma Display Panel (PDP), the method comprising:
arranging first discharge electrodes on a first substrate:
arranging a second substrate to be opposite to the first substrate; and
arranging a plurality of second discharge electrodes on the second substrate at different levels, the plurality of second discharge electrodes being adapted to be addressed by the first discharge electrodes; and
forming a dielectric layer to bury the second discharge electrodes.

13. The method of claim 12, wherein the second discharge electrodes are arranged under discharge cells coated with Red (R), Green (G), and Blue (B) phosphor layers to be different distances away from the first discharge electrodes.

14. The method of claim 13, wherein second discharge electrodes corresponding to discharge cells having higher voltage margins are arranged farther from the first discharge electrodes than second discharge electrodes corresponding to discharge cells having lower voltage margins.

15. The method of claim 13, wherein parts of the dielectric layer that bury the second discharge electrodes arranged under the discharge cells coated with R, G, and B phosphor layers are formed to have different thicknesses.

16. The method of claim 12, wherein forming the second discharge electrodes and the dielectric layer comprises:
forming first electrodes for use as the second discharge electrodes on parts of the second substrate that are under discharge cells coated with a first one of Red (R), Green (G), and Blue (B) phosphor layers;
forming a first dielectric layer to bury the first electrodes;
forming second electrodes for use as the second discharge electrodes on parts of the first dielectric layer that are under the discharge cells coated with a second one of the R, G, and B phosphor layers;
forming a second dielectric layer to bury the second electrodes;
forming third electrodes for use as the second discharge electrodes on parts of the second dielectric layer that are under the discharge cells coated with the phosphor layers of a third one of the R, G, and B phosphor layers; and
forming a third dielectric layer to bury the third electrodes.

17. A Plasma Display Panel (PDP) manufactured by a method, comprising:
arranging first discharge electrodes on a first substrate:
arranging a second substrate to be opposite to the first substrate; and
arranging a plurality of second discharge electrodes on the second substrate at different levels, the plurality of second discharge electrodes being adapted to be addressed by the first discharge electrodes; and
forming a dielectric layer to bury the second discharge electrodes.

18. The PDP of claim 17, wherein the second discharge electrodes are arranged under discharge cells coated with Red (R), Green (G), and Blue (B) phosphor layers to be different distances away from the first discharge electrodes.

19. The PDP of claim 18, wherein second discharge electrodes corresponding to discharge cells having higher voltage margins are arranged farther from the first discharge electrodes than second discharge electrodes corresponding to discharge cells having lower voltage margins.

20. The PDP of claim 18, wherein parts of the dielectric layer that bury the second discharge electrodes arranged under the discharge cells coated with R, G, and B phosphor layers are formed to have different thicknesses.

21. The PDP of claim 17, wherein forming the second discharge electrodes and the dielectric layer comprises:
forming first electrodes for use as the second discharge electrodes on parts of the second substrate that are under discharge cells coated with a first one of Red (R), Green (G), and Blue (B) phosphor layers;
forming a first dielectric layer to bury the first electrodes;
forming second electrodes for use as the second discharge electrodes on parts of the first dielectric layer that are under the discharge cells coated with a second one of the R, G, and B phosphor layers;
forming a second dielectric layer to bury the second electrodes;
forming third electrodes for use as the second discharge electrodes on parts of the second dielectric layer that are under the discharge cells coated with the phosphor layers of a third one of the R, G, and B phosphor layers; and
forming a third dielectric layer to bury the third electrodes.
